(19) United States
(12) Patent Application Publication
(10) Pub. No.: US 2006/0170278 A1
(43) Pub. Date: Aug. 3, 2006

(54) Wheel installation assistant

(75) Inventor: Hung-Kai Chen, Taichung County (TW)

Correspondence Address: BACON & THOMAS, PLLC, 625 SLATERS LANE, FOURTH FLOOR, ALEXANDRIA, VA, 22314, US

(73) Assignee: INFINITE ELECTRONICS INC., TAICHUNG CITY (TW)

(21) Appl. No.: 11/046,845

(22) Filed: Feb. 1, 2005

(51) Int. Cl. B60B 37/00

(52) U.S. Cl. 301/111.01

(57) ABSTRACT

A wheel installation assistant is comprised of a sleeve and an elongated guide section. The sleeve includes an inner diameter which is slightly larger than that of one screw mounted on a vehicle for fitting onto the screw. The sleeve includes a stopping portion inside for contacting against the screw and stopping the screw from further insertion thereinto. The guide section can run through one screw hole of a wheel, having an end connected with the sleeve and the other end extending sidewards for defining a distance from the sleeve in elevation. While applied to the wheel installation, the wheel installation assistant helps the user install the wheel easily and laborsavingly.

### BACKGROUND OF THE INVENTION

1. Field of the Invention

The present invention relates generally to car wheels, and more particularly, to a wheel installation assistant.

2. Description of the Related Art

Generally, when a car driver intends to replace a wheel, the driver usually places a jack under the car and adjacent to where the wheel needs to be replaced, jacks up the car until the wheel is away from the ground for a distance in elevation, and then screws screwnuts off the wheel. In the meantime, since the wheel is insecurely hung on the screws of the hub of the car, the driver can remove the wheel from the hub and then align the screw holes of the wheel rim of a new wheel with the screws of the hub and further push the new wheel towards the hub to enable the screws to run through the screw holes. Finally, the driver can screw the screwnuts to the screws and then jack down the car and remove the jack to complete the wheel installation.

During the replacement, since the car is jacked up by the jack, the wheel has to be raised to enable the alignment of its screw holes with the screws of the hub. However, the wheel including the tire and the wheel rim is too heavy to be raised off the ground for alignment with the hub by a common user who crouches near the car, especially the female. Even if the tire is raised off the ground, it is still difficult to do the alignment well for the user. Further, if the user stands to raise the wheel off the ground, the user may fail to locate the screw holes of the wheel rim to incur failure of accurate alignment of the screws and the screw holes. Thus, there is inconvenient for the aforesaid conventional replacement.

### SUMMARY OF THE INVENTION

The primary objective of the present invention is to provide a wheel installation assistant, which facilitates the screw holes of the wheel in alignment with the screws of the hub.

The secondary objective of the present invention is to provide a wheel installation assistant, which enables the wheel installation to be laborsaving.

The foregoing objectives of the present invention are attained by the wheel installation assistant, which is comprised of a sleeve and an elongated guide section. The sleeve includes an inner diameter which is slightly larger than that of one screw mounted on a vehicle for fitting onto the screw. The sleeve includes a retaining portion inside for contacting against the screw and stopping the screw from further insertion thereinto. The guide section can run through one screw hole of a wheel, having an end connected with the sleeve and the other end extending sidewards for defining a distance from the sleeve in elevation. While applied to the wheel installation, the present invention helps the user install the wheel easily and laborsavingly.

### BRIEF DESCRIPTION OF THE DRAWINGS

FIG. 1 is a perspective view of a preferred embodiment of the present invention.

FIG. 2 is a sectional view of the preferred embodiment of the present invention.

FIG. 3 is a schematic view of the preferred embodiment of the present invention in operation.

FIG. 4 is another schematic view of the preferred embodiment of the present invention in operation.

FIG. 5 shows that the guide section constructed according to the preferred embodiment of the present invention is straight.

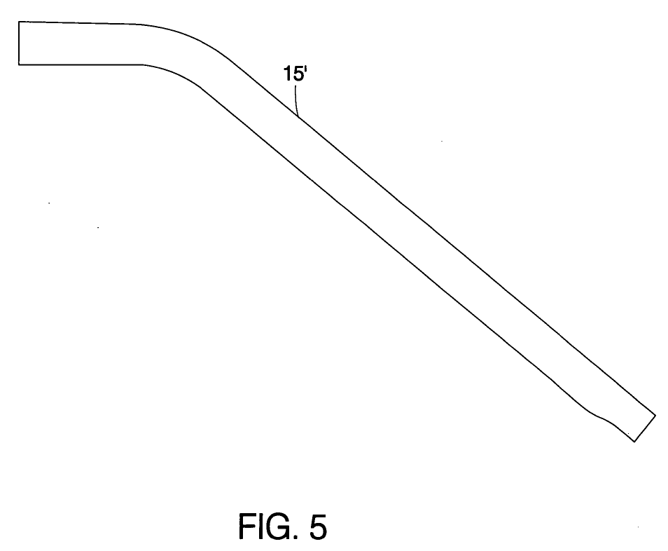

### DETAILED DESCRIPTION OF PREFERRED EMBODIMENTS

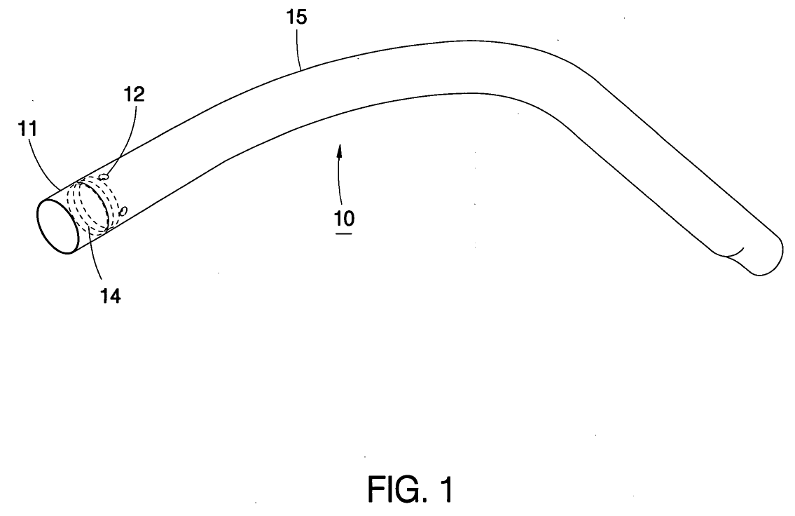

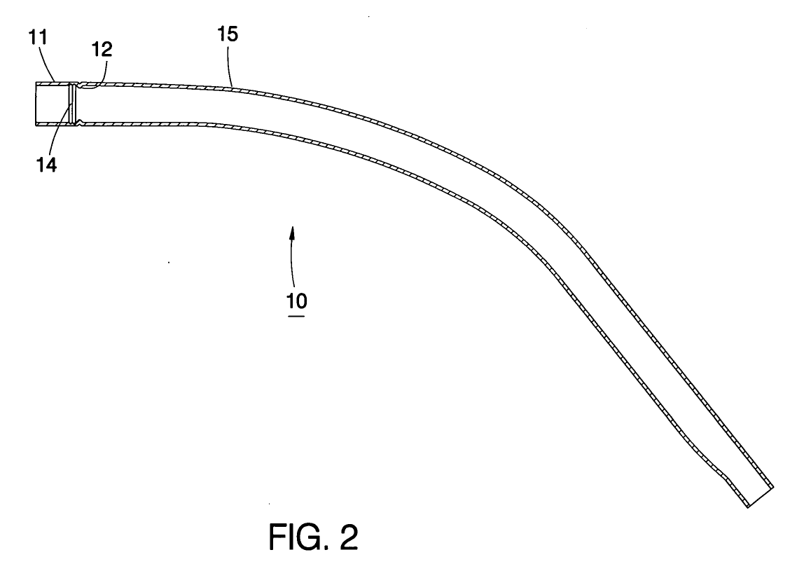

Referring to FIGS. 1-3, a wheel installation assistant 10 constructed according to a preferred embodiment of the present invention is comprised of a sleeve 11 and a guide section 15.

The sleeve 11 includes a stopping portion 12 formed on an internal periphery thereof and abutting an end thereof, having an inner diameter thereof that is slightly larger than that of one of screws 71 mounted on a hub of a vehicle 70, for fitting onto the screw 71 and overlapping a part of the screw 71 by the stopping portion 12 contacting against a free end of the screw 71. The overlap of the screw 71 and the stopping portion 12 is shorter than the screw 71 in length to ensure the sleeve 11 not to fully but partially cover the screw 7, exposing a predetermined length of an external side of the screw 71. The sleeve 11 further includes a thread-like portion 14 for interference with the screw 71 to prevent the sleeve 11 from accidental disengagement from the screw 71.

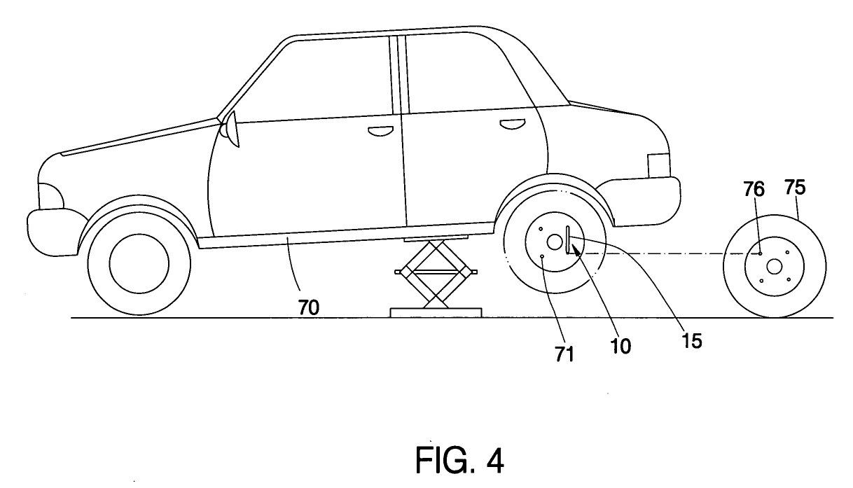

The guide section 15 is elongated and arced for running through one of screw holes of a wheel rim, as shown in FIG. 4, having an end connected with the other (distal) end of the sleeve 11 and extending sidewards from the sleeve such that there is a distance between the distal end of the guide section 15 and the sleeve 11 in elevation. The guide section 15 further includes a part of predetermined length abutting the distal end thereof and having a diameter is slightly smaller than the other part thereof for inserting through the screw hole of the wheel rim. In addition, the sleeve 11 and the guide section 15 are formed of a curved tubular member as one piece.

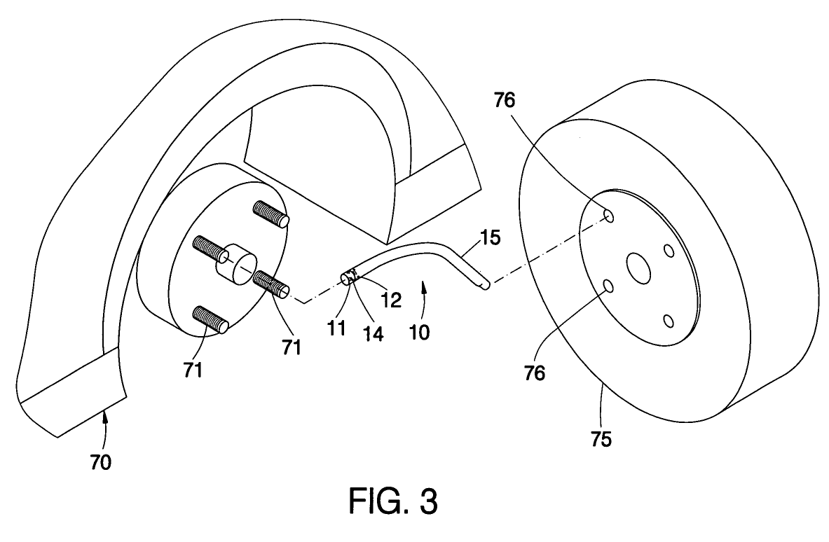

Referring to FIG. 3 again, during the operation of the present invention, the user has to let the sleeve 11 fit onto one screw 71 to enable the stopping portion 12 to stop the screw 71 from further insertion. In the meantime, the screw 71 is partially covered by the sleeve 11 at its external end to expose its root. The thread-like portion 14 of the sleeve 11 also has interference with the screw 71 for preventing the sleeve 11 from accidental disengagement. Rotate the guide section 15 with respect to the screw 71 to enable the distal end of the guide section 15 to be lower than the sleeve 11. As shown in FIG. 4, roll a spare tire 75 to approach the distal end of the guide section 15 and align one screw hole 76 of the wheel rim with the distal end of the guide section 15 by rolling the spare tire 75 and turning the sleeve 11. Next, push the spare tire 75 towards the guide section 15 to enable the guide section 15 to insert through the screw hole 76, such that the user can push the spare tire to approach the screw 71 by the sideward guidance of the guide section 15. Meanwhile, the spare tire 75 is supported by the wheel installation assistant 10, and thus the user doesn't have to raise the spare tire 75 with great strength but to turn the guide section 15 to enable the screw holes of the spare tire to align with the screws with little strength, and then the user can further push the spare tire 75 towards the screws 71 to enable the spare tire 75 to fully fit onto the screws 71. Since the root of the screw 71 is not covered by the sleeve 11, after pushed further, the spare tire 75 is positioned at the root of the screw 71 without interference with the sleeve 11, and thus the user can directly remove the sleeve 11 and then install screwnuts (not shown) onto the screws 71 to complete the wheel installation. In addition, if the thread-like portion 14 of the sleeve 11 has too much interference with the screw, the user can turn the guide section 15 to easily remove the sleeve 11 like screwing off a screw nut.

Further, the guide section 15′ can alternatively be straight, attaining the same function with the guide section 15.

In conclusion, the present invention includes the following advantages:

1. The user can easily align the screw holes of the wheel with the screws of the hub to finish the wheel installation easily.

2. The user doesn't have to raise the wheel with great strength but to push the wheel sidewards along the guide section with little strength to have a laborsaving job.

What is claimed is:

1. A wheel installation assistant for helping the user install a wheel onto a vehicle, said wheel having screw holes, said vehicle having screws for inserting through said screw holes, said wheel installation assistant comprising:
a sleeve having a stopping portion inside for contacting against said screw of said vehicle, said sleeve having an inner diameter slightly larger than that of one of said screws of said vehicle for fitting onto said screw of said vehicle, said stopping portion stopping said screw from further insertion into said sleeve to keep said sleeve covered onto a part of said screw; and
an elongated guide section having an end connected with said sleeve and the other end extending sidewards from said sleeve for running through said screw hole of said wheel and defining a distance from said sleeve in elevation.

2. The wheel installation assistant as defined in claim 1, wherein said sleeve defines a part between said stopping portion and an external end thereof abutting said stopping portion, said part having a length smaller than that of said screw of said vehicle.

3. The wheel installation assistant as defined in claim 1, wherein said sleeve further comprises a thread-like portion inside.

4. The wheel installation assistant as defined in claim 1, wherein said guide section and said sleeve are formed of a tubular member as one piece.

5. The wheel installation assistant as defined in claim 1, wherein said guide section comprises a part at a distal end thereof and having a diameter slightly smaller than that of the other part thereof.

6. The wheel installation assistant as defined in claim 1, wherein said guide section is arced in shape.

7. The wheel installation assistant as defined in claim 1, wherein said guide section is straight in shape.
